(19) United States
(12) Patent Application Publication
(10) Pub. No.: US 2025/0105552 A1
(43) Pub. Date: Mar. 27, 2025

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Takanori OSAWA, Osaka (JP); Keigo TAKAHASHI, Osaka (JP)

(21) Appl. No.: 18/720,808

(22) PCT Filed: Dec. 27, 2022
(86) PCT No.: PCT/JP2022/048232

§ 371 Date: Jun. 17, 2024

(30) Foreign Application Priority Data
Dec. 27, 2021 (JP) 2021-212030

(51) Int. Cl. H01R 13/58

(52) U.S. Cl. CPC H01R 13/582

(57) ABSTRACT

A connector includes a housing body (11) formed with a module accommodation chamber (15) and a routing space (12), a cover (30) for closing an opening (13) of the routing space in an outer surface of the housing body (11), a pressing member (40) mounted in the routing space (12), and a terminal module (60) including a terminal fitting (62) connected to a wire (71, 72, 76) and inserted into the module accommodation chamber (15). The wire (71, 72, 76) drawn out into the routing space (12) from the module accommodation chamber (15) is routed while being sandwiched and bent between the cover (30) and the pressing member (40). A mounting direction of the pressing member (40) is a direction approaching the module accommodation chamber (15).

### TECHNICAL FIELD

The present disclosure relates to a connector.

### BACKGROUND

An L-shaped connector disclosed in Patent Document 1 is provided with an inner housing and an L-shaped terminal to be connected to a shielded cable and accommodated into the inner housing. The shielded cable connected to the L-shaped terminal by crimping is drawn out from the lower end of the inner housing.

### PRIOR ART DOCUMENT

### Patent Document

Patent Document 1: JP 2011-119120 A

### SUMMARY OF THE INVENTION

### Problems to be Solved

In the connector of Patent Document 1, if the shielded cable is pulled downward, a pulling force acts on a connected part of the shielded cable and the L-shaped terminal. Thus, the connected part of the shielded cable and the L-shaped terminal may be damaged and the shielded cable may be detached from the L-shaped terminal.

A connector of the present disclosure was completed on the basis of the above situation and aims to suppress the damage of a connected part of a wire and a terminal fitting.

### Means to Solve the Problem

The present disclosure is directed to a connector with a housing body formed with a module accommodation chamber and a routing space, a cover for closing an opening of the routing space in an outer surface of the housing body, a pressing member mounted in the routing space, and a terminal module including a terminal fitting connected to a wire, the terminal module being inserted in the module accommodation chamber, the wire drawn out into the routing space from the module accommodation chamber being routed while being sandwiched and bent between the cover and the pressing member, and a mounting direction of the pressing member into the routing space being a direction approaching the module accommodation chamber.

### Effect of the Invention

According to the present disclosure, it is possible to suppress the damage of a connected part of a wire and a terminal fitting.

### BRIEF DESCRIPTION OF THE DRAWINGS

FIG. 1 is a perspective view of a connector when viewed obliquely from behind.

FIG. 2 is a perspective view of the connector in a disassembled state when viewed obliquely from behind.

FIG. 3 is a side view in section showing a state where a terminal module is mounted in a housing body.

FIG. 4 is a side view in section showing a state where a cover is mounted on the housing body having the terminal module mounted therein.

FIG. 5 is a side view in section showing a state where a pressing member is further mounted in the housing body after the cover is mounted on a housing.

FIG. 6 is a side view in section of the connector in an assembly completed state.

### DETAILED DESCRIPTION TO EXECUTE THE INVENTION

### Description of Embodiments of Present Disclosure

First, embodiments of the present disclosure are listed and described.

(1) The connector of the present disclosure is provided with a housing body formed with a module accommodation chamber and a routing space, a cover for closing an opening of the routing space in an outer surface of the housing body, a pressing member mounted in the routing space, and a terminal module including a terminal fitting connected to a wire, the terminal module being inserted in the module accommodation chamber, the wire drawn out into the routing space from the module accommodation chamber being routed while being sandwiched and bent between the cover and the pressing member, and a mounting direction of the pressing member into the routing space being a direction approaching the module accommodation chamber. According to this configuration, since a strain relief portion is constituted by the cover and the pressing member, even if a pulling force acts on the wire outside the housing body, the pulling force does not reach a connected part of the wire and the terminal fitting. In the process of mounting the pressing member into the routing space, since the pressing member presses a part of the wire routed in the routing space toward the module accommodation chamber, the pulling force does not act between the wire in the routing space and the terminal fitting in the module accommodation chamber. Therefore, it is possible to suppress the damage of the connected part of the wire and the terminal fitting.

(2) Preferably, the pressing member has a pressing surface facing the module accommodation chamber, the cover includes a protrusion projecting in a direction intersecting the mounting direction of the pressing member, the protrusion being arranged in the routing space, the protrusion is formed with a receiving surface for sandwiching the wire between the pressing surface and the receiving surface, and a mounting direction of the cover on the housing body is the same direction as the projecting direction of the protrusion. According to this configuration, if the cover is mounted on the housing body with the pressing member removed from the housing body, the wire is pressed by the protrusion. If the pressing member is mounted in this state, the wire is pressed toward the module accommodation chamber by the pressing surface and sandwiched and bent between the pressing surface and the receiving surface.

(3) Preferably, the wires include two signal wires constituting a differential pair wire, the differential pair wire constitutes one shielded cable by being embedded in a twisted state in a sheath, and a part embedded in the sheath, out of the differential pair wire, is sandwiched and bent between the cover and the pressing member. According to this configuration, since an untwisted length of the differential pair wire can be shortened, communication performance is excellent. Since a part of the differential pair wire exposed from the sheath is low in stiffness, this part is easily shifted in position in an axial direction even if being sandwiched between the cover and the pressing member. In contrast, since a part of the shielded cable, in which the differential pair wire is embedded in the sheath, is higher in stiffness than the exposed part of the differential pair wire, this part is hardly shifted in position in the axial direction by being sandwiched between the cover and the pressing member.

(4) Preferably, the wires include a power supply wire and a ground wire, the power supply wire and the ground wire constitute one multi-core cable by being embedded in an insulation coating, and parts embedded in the insulation coating, out of the power supply wire and the ground wire, are sandwiched and bent between the cover and the pressing member. According to this configuration, since parts of the power supply wire and the ground wire exposed from the insulation coating are low in stiffness, these parts are easily shifted in position in the axial direction even if being sandwiched between the cover and the pressing member. In contrast, since a part of the multi-core cable, in which the power supply wire and the ground wire are embedded in the insulation coating, is higher in stiffness than the exposed parts of the power supply wire and the ground wire, this part is hardly shifted in position in the axial direction by being sandwiched between the cover and the pressing member.

(5) Preferably, a plurality of cables having the wires embedded therein are provided, the plurality of cables are routed side by side in a width direction intersecting a routing direction of the plurality of cables in the routing space, and the pressing member includes a partition wall for partitioning between the plurality of cables. According to this configuration, the plurality of cables can be prevented from being routed on one side in the width direction in the routing space.

### DETAILS OF EMBODIMENTS OF PRESENT DISCLOSURE

### Embodiment

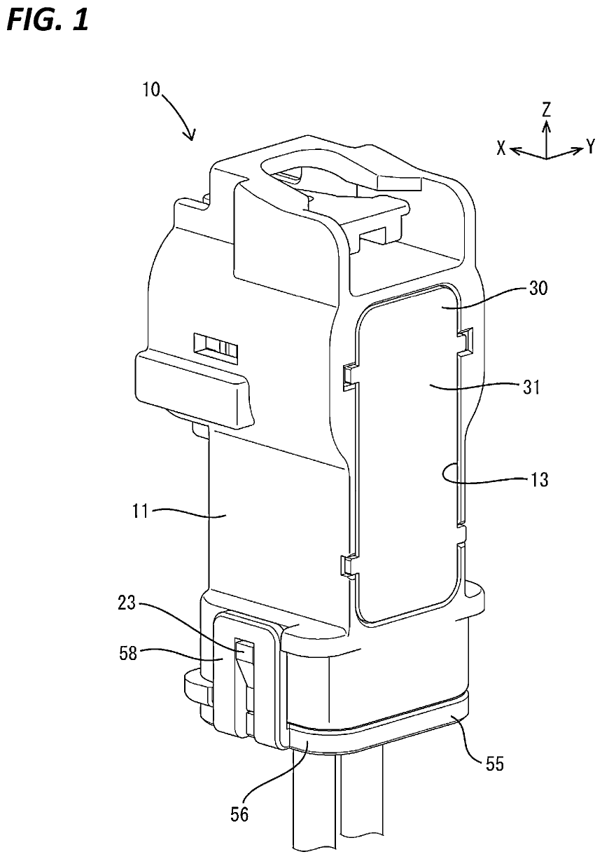

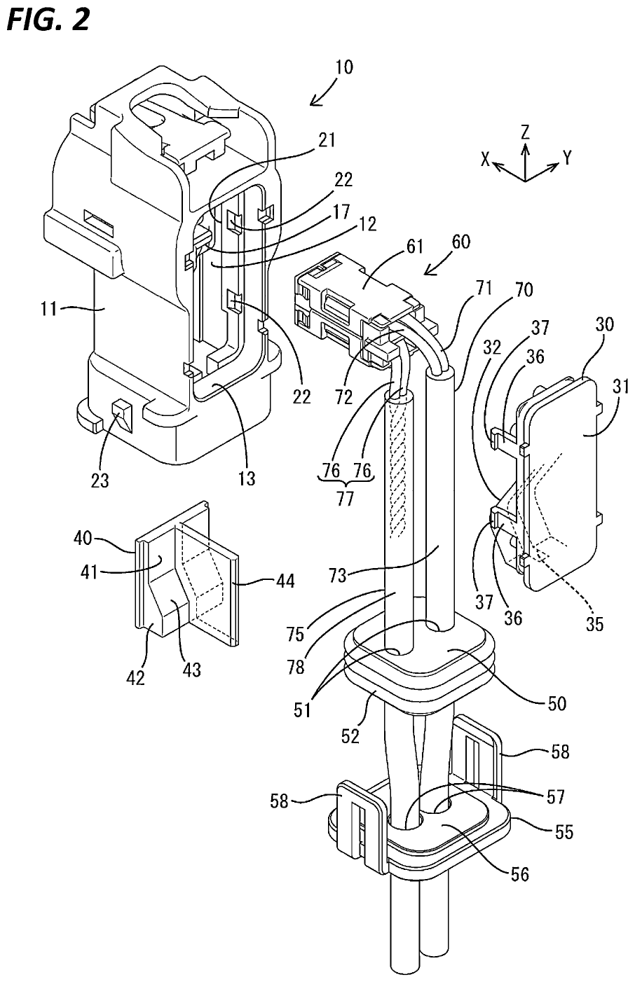

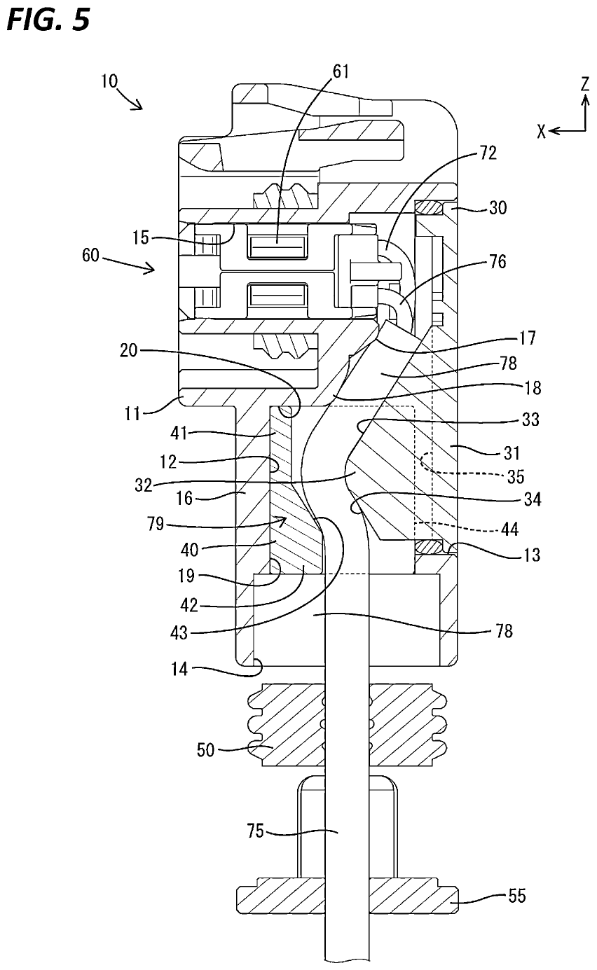

A specific embodiment of the present disclosure is described with reference to FIGS. 1 to 6. Note that the present invention is not limited to these illustrations, but is represented by claims and intended to include all changes in the scope of claims and in the meaning and scope of equivalents. In this embodiment, a positive direction along an X axis in FIGS. 1 to 6 is defined as a forward direction concerning a front-rear direction. A positive direction along a Y axis in FIGS. 1 and 2 is defined as a rightward direction concerning a lateral direction. A positive direction along a Z axis in FIGS. 1 to 6 is defined as an upward direction concerning a vertical direction.

### First Embodiment

As shown in FIGS. 1 to 3, a connector of this embodiment is configured by assembling a housing 10 and a terminal module 60. The housing 10 is configured by assembling a housing body 11 made of synthetic resin, a cover 30 made of synthetic resin, a pressing member 40 made of synthetic resin, a rubber plug 50 and a holder 55 made of synthetic resin.

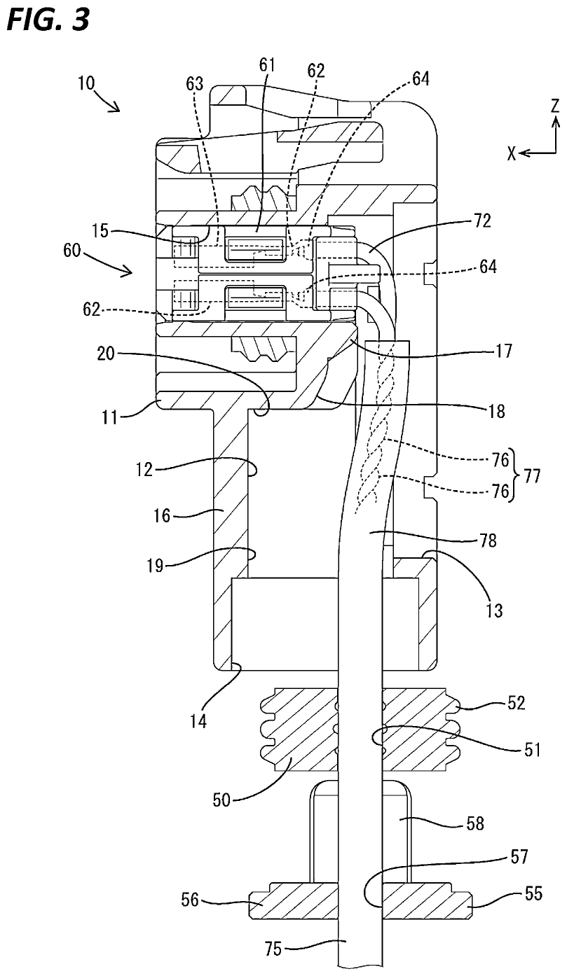

The housing body 11 is a single component. As shown in FIGS. 2 to 6, a routing space 12 is formed inside the housing body 11. A rear opening 13 communicating with the routing space 12 is formed in a rear surface, out of the outer surface of the housing body 11. As shown in FIGS. 3 to 6, a lower opening 14 communicating with the routing space 12 is formed in a lower surface at a right angle to the rear surface, out of the outer surface of the housing body 11. The rear opening 13 and the lower opening 14 are independent openings not communicating with each other. A module accommodation chamber 15 penetrating through the housing body 11 in the front-rear direction is formed in an upper end part of the housing body 11. The front end of the module accommodation chamber 15 is open in the front surface of the housing body 11. The rear end of the module accommodation chamber 15 communicates with a space in an upper end part of the routing space 12 and is exposed to the outside of the housing body 11 in the rear opening 13.

An upper pushing portion 17 and a lower pushing portion 18 are formed in an upper end region of a front wall portion 16 constituting the routing space 12. The upper pushing portion 17 is in the shape of a projection facing the routing space 12 and bulging obliquely downward from the rear surface of the front wall portion 16. The lower pushing portion 18 is in the shape of a projection facing the routing space 12 and bulging obliquely downward from the rear surface of the front wall portion 16. The lower pushing portion 18 is located below the upper pushing portion 17 and behind the upper pushing portion 17. As shown in FIG. 3, in a side view of the housing body 11, a region where the upper and lower pushing portions 17, 18 are formed, out of the rear surface of the front wall portion 16, is inclined in an overhanging manner to be lower toward the front.

A region below the lower pushing portion 18, out of the routing space 12, functions as an accommodation space 19 for accommodating the pressing member 40 to be described later. A region constituting the accommodation space 19, out of the rear surface of the front wall portion 16, is located in front of the lower pushing portion 18. That is, the region constituting the accommodation space 19, out of the rear surface of the front wall portion 16, is recessed forward with respect to the lower pushing portion 18. The upper surface of the accommodation space 19 connected to the lower pushing portion 18 functions as a stopper 20 facing downward (toward the lower opening 14).

A pair of locking portions 21 (see FIG. 2) extending in the vertical direction are formed on the inner surfaces of both left and right side wall portions constituting the routing space 12. A front end part of the locking portion 21 has such a step shape as to form a locking surface (not shown) facing forward (toward a side opposite to the rear opening 13 in the front-rear direction). A pair of upper and lower guide portions 22 are formed in each of the inner surfaces of the both locking portions 21 facing each other. The guide portion 22 is in the form of a groove inclined to be gradually shallower toward the front. A pair of lock projections 23 are formed on both left and right outer side surfaces of the housing body 11.

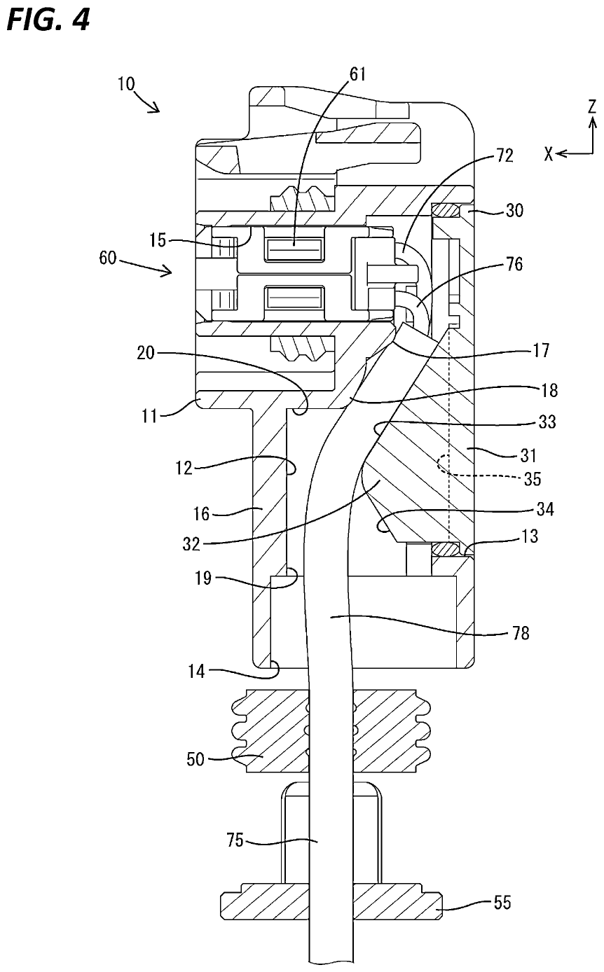

As shown in FIG. 2, the cover 30 is a single component including a plate-like body portion 31, one protrusion 32 and two pairs of resilient locking pieces 36. The plate-like body portion 31 is shaped and sized to cover the rear opening 13. The protrusion 32 projects forward from the front surface of the plate-like body portion 31. As shown in FIGS. 4 to 6, the upper surface (upper end region of a front surface) of the protrusion 32 serves as a supporting surface 33 inclined to be gradually lower toward the front. The lower surface (lower end region of the front surface) of the protrusion 32 serves as a receiving surface 34 inclined to be gradually higher toward the front. The protrusion 32 is formed with a groove portion 35. The groove portion 35 is in the form of a slit extending in the vertical direction and formed by recessing an entire region of the front surface of the protrusion 32 from an upper end to a lower end.

As shown in FIG. 2, the resilient locking pieces 36 are cantilevered forward from both left and right side edges of the plate-like body portion 31. A pair of the resilient locking pieces 36 spaced apart in the vertical direction are arranged on each side edge part. A locking projection 37 is formed on a front end part of the resilient locking piece 36. The resilient locking piece 36 can be resiliently deformed in the lateral direction.

The cover 30 is assembled with a rear surface part of the housing body 11 to close the rear opening 13. In the process of mounting the cover 30, the locking projections 37 are fit into the guide portions 22, whereby the cover 30 is positioned in the vertical direction and lateral direction with respect to the housing body 11 and the cover 30 is guided to move in the front-rear direction. In the mounting process of the cover 30, the locking projections 37 slide in contact with the guide portions 22, whereby the resilient locking pieces 36 are resiliently deformed. If the cover 30 is mounted on the housing body 11, the plate-like body portion 31 closes the entire region of the rear opening 13. The resilient locking pieces 36 resiliently return and the locking projections 37 are locked to the front end parts of the locking portions 21 from front. By this locking, the cover 30 is held mounted on the housing body 11.

With the cover 30 mounted on the housing body 11, the protrusion 32 is arranged in the routing space 12 and the upper end region of the supporting surface 33 and the upper and lower pushing portions 17, 18 are positioned to face each other in the front-rear direction at the same height. In a side view, the supporting surface 33 is parallel to a virtual line connecting a rearward projecting end of the upper pushing portion 17 and that of the lower pushing portion 18. A lower end region of the supporting surface 33 is arranged at the same height as the upper end region of the accommodation space 19. The receiving surface 34 is arranged at the same height as the lower end region of the accommodation space 19.

As shown in FIG. 2, the pressing member 40 is a single component including a wall-like base portion 41 and a partition wall 44. The wall-like base portion 41 is a part having a wall thickness direction oriented in the front-rear direction. In a front view of the pressing portion 40, the wall-like base portion 41 has a rectangular shape. As shown in FIGS. 2, 5 and 6, a pressing portion 42 is formed in a lower end region of the rear surface of the wall-like base portion 41. A pressing surface 43 inclined to be gradually lower toward the rear in a side view is formed in an upper end region of the rear surface of the pressing portion 42.

The partition wall 44 is cantilevered rearward from lateral center positions of the rear surface of the wall-like base portion 41 and the pressing portion 42 (pressing surface 43). The partition wall 44 is arranged with a wall thickness direction oriented in the lateral direction. A side view shape of a coupled part of the pressing portion 42 and the partition wall 44 is a rectangular shape. A formation region of the partition wall 44 in the vertical direction is a range from the upper end to the lower end of the wall-like base portion 41.

The pressing member 40 is mounted into the routing space 12 through the lower opening 14 from below the housing body 11. With the pressing member 40 mounted, the wall-like base portion 41 is arranged to overlap the rear surface of the front wall portion 16 of the housing body 11. The pressing member 40 is positioned in the vertical direction with respect to the housing body 11 by the contact of the upper end of the wall-like base portion 41 with the stopper 20 of the housing body 11 from below. The pressing portion 42 and the pressing surface 43 of the pressing member 40 are located in front of the front end of the protrusion 32 of the cover 30. The pressing surface 43 and the receiving surface 34 of the cover 30 are positioned to face each other in the front-rear direction at the same height. In a side view, the pressing surface 43 and the receiving surface 34 are parallel. A rear end edge part of the partition wall 44 is fit into the groove portion 35 of the cover 30. The partition wall 44 is arranged to partition the inside of the routing space 12 into two left and right chambers.

The rubber plug 50 is a single component including a pair of left and right sealing holes 51. The sealing holes 51 penetrate through the rubber plug 50 in the vertical direction. A lip portion 52 is formed on the outer peripheral surface of the rubber plug 50. The holder 55 is a single component including a plate-like pushing portion 56 and a pair of left and right lock arms 58. The plate-like pushing portion 56 is a part having a plate thickness direction oriented in the vertical direction. The plate-like pushing portion 56 is formed with a pair of left and right cable insertion holes 57. The pair of lock arms 58 are cantilevered upward from both left and right side edges of the plate-like pushing portion 56.

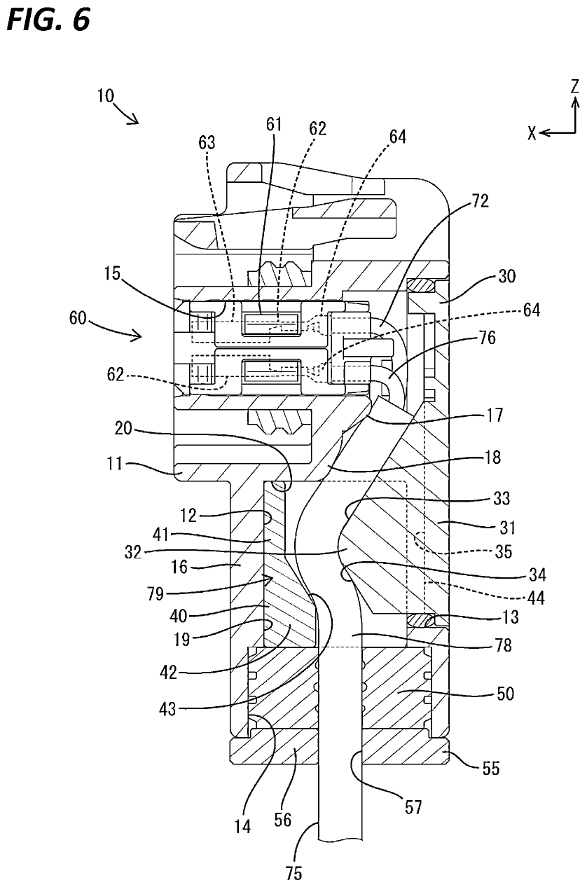

As shown in FIGS. 3 and 6, the terminal module 30 includes a case 61 made of synthetic resin and two pairs of terminal fittings 62 accommodated in the case 61. The two pairs of terminal fittings 62 are accommodated separately in two upper and lower stages. The terminal fitting 62 is a single component including a terminal body portion 63 in the form of a rectangular tube and a crimping portion 64 connected to the rear end of the terminal body portion 63.

A power supply wire 71 (see FIG. 2) constituted by a coated wire is connected to the crimping portion 64 of one terminal fitting 62, out of a pair of the terminal fittings 62 to be accommodated in the upper stage of the case 61. A ground wire 72 (see FIG. 2) constituted by a coated wire is connected to the crimping portion 64 of the other terminal fitting 62. The power supply wire 71 and the ground wire 72 are embedded in a common insulation coating 73. One multi-core cable 70 is constituted by the power supply wire 71, the ground wire 72 and the insulation coating 73. The multi-core cable 70 has a circular cross-sectional shape. An end of the multi-core cable 70 on a side connected to the terminal fittings 62 constitutes the terminal module 60.

As shown in FIGS. 3 and 6, a signal wire 76 (see FIG. 2) constituted by a coated wire is connected to the crimping portion 64 of each of a pair of the terminal fittings 62 accommodated in the lower stage of the case 61. Two signal wires 76 constitute a differential pair wire 77. The differential pair wire 77 is embedded in a twisted state in a common sheath 78. The differential pair wire 77 constitutes a twisted pair wire. One shielded cable 75 is constituted by the differential pair wire 77 and the sheath 78. The shielded cable 75 (sheath 78) has a circular cross-sectional shape. An end of the shielded cable 75 on a side connected to the terminal fittings 62 constitutes the terminal module 60.

In the terminal module 60, an end part of the insulation coating 73 and an end part of the sheath 78 are located near the case 61. That is, lengths of parts of the power supply wire 71 and the ground wire 72 exposed from the insulation coating 73 are minimum necessary lengths to mount the terminal fittings 62 into the case 61. Lengths of parts of the signal wires 76 exposed from the insulation coating 73 are minimum necessary lengths to mount the terminal fittings 62 into the case 61.

The rubber plug 50 and the holder 55 described above are mounted on the multi-core cable 70 and the shielded cable 75 before the terminal module 60 is mounted into the housing body 11. The multi-core cable 70 and the shielded cable 75 are inserted through the sealing holes 51 of the rubber plug 50 and the cable insertion holes 57 of the holder 55. The rubber plug 50 is arranged at a position closer to the terminal fittings 62 than the holder 55.

Next, an assembly procedure of the connector is described. The terminal module 60 is inserted into the routing space 12 through the lower opening 14, and pulled to a side behind and outside the housing body 11 through the rear opening 13. The pulled-out terminal module 60 is inserted into the module accommodation chamber 15 through the rear opening 13. The terminal module 60 inserted into the module accommodation chamber 15 is retained by a retaining portion (not shown) provided in the housing body 11.

The upper end of the insulation coating 73 of the multi-core cable 70 and that of the sheath 78 of the shielded cable 75 are located substantially at the same height as the upper pushing portion 17. Since a part of the multi-core cable 70, in which the power supply wire 71 and the ground wire 72 are exposed, is lower in stiffness than a part covered by the insulation coating 73, this part is bent with a relatively large curvature and arranged in the routing space 12. Regions of the power supply wire 71 and the ground wire 72 embedded in the insulation coating 73 are also routed in the routing space 12. Since a part of the shielded cable 75, in which the signal wires 76 are exposed, is lower in stiffness than a part embedded in the sheath 78, this part is bent with a relatively large curvature and arranged in the routing space 12. Regions of the signal wires 76 embedded in the sheath 78 are also routed in the routing space 12.

After the terminal module 60 is mounted, the cover 30 is mounted on the housing body 11. In the process of mounting the cover 30, the front end part of the protrusion 32 contacts the insulation coating 73 and the sheath 78 and pushes the multi-core cable 70 and the shielded cable 75 forward. At this time, since the power supply wire 71, the ground wire 72 and the signal wires 76 relatively low in stiffness are flexibly bent and deformed, a large load (pulling force) does not act on a connected part of the power supply wire 71 and the terminal fitting 62, a connected part of the ground wire 72 and the terminal fitting 62 and connected parts of the signal wires 76 and the terminal fittings 62. If the cover 30 is mounted on the housing body 11, the insulation coating 73 and the sheath 78 are pressed against the upper and lower pushing portions 17, 18 by the supporting surface 33. The multi-core cable 70 and the shielded cable 75 are sandwiched in the front-rear direction between the housing body 11 and the cover 30.

After the cover 30 is mounted, the pressing member 40 is mounted into the housing body 11. A mounting direction of the pressing member 40 is the upward direction. In the process of mounting the pressing member 40, the pressing portion 42 contacts the insulation coating 73 and the sheath 78 from front, wherefore friction resistance is generated between the pressing member 40 and the multi-core cable 70 and between the pressing member 40 and the shielded cable 75. By this friction force, an upward pressing force is applied to the multi-core cable 70 and the shielded cable 75. Therefore, no pulling force acts on a connected part of the crimping portion 64 of the terminal fitting 62 and the power supply wire 71, a connected part of the crimping portion 64 of the terminal fitting 62 and the ground wire 72 and connected parts of the crimping portions 64 of the terminal fittings 62 and the signal wires 76.

If the pressing member 40 is mounted into the housing body 11, the multi-core cable 70 and the shielded cable 75 are sandwiched in the front-rear direction between the pressing surface 43 and the receiving surface 34. In a side view, a direction of inclination of parts of the multi-core cable 70 and the shielded cable 75 sandwiched between the supporting surface 33 and the upper and lower pushing portions 17, 18 and a direction of inclination of parts of the multi-core cable 70 and the shielded cable 75 sandwiched between the pressing surface 43 and the receiving surface 34 are different. The multi-core cable 70 and the shielded cable 75 are pushed forward by the front end of the protrusion 32 and pushed rearward by the rear end of the pressing portion 42, thereby being routed in a bent state in a side view.

After the pressing member 40 is mounted, the rubber plug 50 and the holder 55 are slid upward and the lock arms 58 of the holder 55 are locked to the lock projections 23 of the housing body 11. In this way, the pressing member 40 is held mounted in the routing space 12, and the rubber plug 50 and the holder 55 are held mounted in the housing body 11. In the above way, the assembly of the connector is completed.

If the multi-core cable 70 and the shielded cable 75 are pulled downward on a side below and outside the connector, the insulation coating 73 of the multi-core cable 70 and the sheath 78 of the shielded cable 75 are caught by the lower end edge of the pressing surface 43 in the pressing portion 42 and caught by the front end of the protrusion 32 (lower end edge of the supporting surface 33). By being caught in this way, downward movements of the multi-core cable 70 and the shielded cable 75 are restricted. Thus, no load in a pulling direction acts on the connected part of the terminal fitting 62 and the power supply wire 71, the connected part of the terminal fitting 62 and the ground wire 72 and the connected parts of the terminal fittings 62 and the signal wires 76.

The connector of this embodiment includes the housing body 11, the cover 30, the pressing member 40 and the terminal module 60. The housing body 11 is formed with the module accommodation chamber 15 and the routing space 12. The cover 30 closes the opening (rear opening 13) of the routing space 12 in the outer surface of the housing body 11. The pressing member 40 is mounted into the routing space 12. The terminal module 60 includes the terminal fittings 62 connected to any one of the power supply wire 71, the ground wire 72 and the signal wires 76, and is inserted into the module accommodation chamber 15. The power supply wire 71, the ground wire 72 and the signal wires 76 drawn out into the routing space 12 from the module accommodation chamber 15 are routed while being sandwiched and bent between the cover 30 and the pressing member 40. The mounting direction of the pressing member 40 into the routing space 12 is a direction approaching the module accommodation chamber 15, i.e. the upward direction.

A strain relief portion 79 is configured in the housing 10 by the upper and lower pushing portions 17, 18 of the housing body 11, the protrusion 32 of the cover 30 and the pressing portion 42 of the pressing member 40. Even if a pulling force acts on the multi-core cable 70 (power supply wire 71 and ground wire 72) and the shielded cable 75 (signal wires 76) outside the housing body 11, the pulling force is prevented from reaching the connected parts of these wires 71, 72 and 76 and the terminal fittings 62 by the strain relief portion 79. In the process of mounting the pressing member 40 into the routing space 12, no pulling force acts between the wires 71, 72 and 76 in the routing space 12 and the terminal fittings 62 in the module accommodation chamber 15 since the pressing member 40 presses the parts of the wires 71, 72 and 76 routed in the routing space 12 toward the module accommodation chamber 15. Therefore, it is possible to suppress the damage of the connected parts of the wires 71, 72 and 76 and the terminal fittings 62.

The pressing member 40 has the pressing surface 43 facing toward the module accommodation chamber 15. The cover 30 includes the protrusion 32 projecting in a direction (forward direction) intersecting the mounting direction of the pressing member 40. The protrusion 32 is arranged in the routing space 12. The protrusion 32 is formed with the receiving surface 34 for sandwiching the wires 71, 72 and 76 (multi-core cable 70 and shielded cable 75) between the pressing surface 43 and the receiving surface 34. A mounting direction of the cover 30 on the housing body 11 is the same direction (forward direction) as the projecting direction of the protrusion 32. If the cover 30 is mounted on the housing body 11 with the pressing member 40 removed from the housing body 11, the wires 71, 72 and 76 (multi-core cable 70 and shielded cable 75) are pressed forward by the protrusion 32. If the pressing member 40 is mounted in this state, the wires 71, 72 and 76 (multi-core cable 70 and shielded cable 75) are pressed toward the module accommodation chamber 15 (upward) by the lower end edge of the pressing surface 43 and sandwiched and bent between the pressing surface 43 and the receiving surface 34.

The wires 71, 72 and 76 include the two signal wires 76 constituting the differential pair wire 77. The differential pair wire 77 (two signal wires 76) constitutes one shielded cable 75 by being embedded in a twisted state in the sheath 78. Apart of the differential pair wire 77 embedded in the sheath 78 is sandwiched and bent between the cover 30 and the pressing member 40. According to this configuration, since an untwisted length (exposed length from the sheath 78) of the differential pair wire 77 can be shortened, communication performance is excellent. Since a part of the differential pair wire 77 exposed from the sheath 78 is low in stiffness, this part is easily shifted in position in an axial direction (vertical direction) even if being sandwiched between the cover 30 and the pressing member 40. In contrast, since the part of the shielded cable 75, in which the differential pair wire 77 is embedded in the sheath 78, is higher in stiffness than the exposed part of the differential pair wire 77, this part is hardly shifted in position in the axial direction by being sandwiched between the cover 30 and the pressing member 40.

The wires 71, 72 and 76 include the power supply wire 71 and the ground wire 72. The power supply wire 71 and the ground wire 72 constitute one multi-core cable 70 by being embedded in the insulation coating 73 having the same diameter as the sheath 78. The shielded cable 75 and the multi-core cable 70 are routed in parallel in the width direction (lateral direction). The parts of the power supply wire 71 and the ground wire 72 embedded in the insulation coating 73 are sandwiched and bent between the cover 30 and the pressing member 40. Since the parts of the power supply wire 71 and the ground wire 72 exposed from the insulation coating 73 are low in stiffness, these parts are easily shifted in position in the axial direction (vertical direction) even if being sandwiched between the cover 30 and the pressing member 40. In contrast, since the part of the multi-core cable 70, in which the power supply wire 71 and the ground wire 72 are embedded in the insulation coating 73, is higher in stiffness than the exposed parts of the power supply wire 71 and the ground wire 72, this part is hardly shifted in position in the axial direction by being sandwiched between the cover 30 and the pressing member 40.

The connector includes two (a plurality of) cables (multi-core cable 70 and shielded cable 75) embedded with the wires 71, 72 and 76. The multi-core cable 70 and the shielded cable 75 are routed side by side in the width direction intersecting a routing direction (vertical direction) of the multi-core cable 70 and the shielded cable 75 in the routing space 12. The pressing member 40 includes the partition wall 44 for partitioning between the multi-core cable 70 and the shielded cable 75. By providing the partition wall 44, the multi-core cable 70 and the shielded cable 75 can be prevented from being routed on one side in the width direction (e.g. on the side of the multi-core cable 70).

### Other Embodiments

The present invention is not limited to the above described and illustrated embodiment, but is represented by claims. The present invention includes all changes in the scope of claims and in the meaning and scope of equivalents and also includes the following embodiments.

The present invention is applicable also when the terminal module is not connected to the differential pair wire.

The present invention is applicable also when the power supply wire and the ground wire do not constitute the multi-core cable.

The pressing member may include no partition wall.

The partition wall may be formed on the cover.

One, three or more cables may be provided.

List of Reference Numerals

| | |
|---|---|
| 10 | housing |
| 11 | housing body |
| 12 | routing space |
| 13 | rear opening (opening of routing space |
| | in outer surface of housing body) |
| 14 | lower opening |
| 15 | module accommodation chamber |
| 16 | front wall portion |
| 17 | upper pushing portion |
| 18 | lower pushing portion |
| 19 | accommodation space |
| 20 | stopper |
| 21 | locking portion |
| 22 | guide portion |
| 23 | lock projection |
| 30 | cover |
| 31 | plate-like body portion |
| 32 | protrusion |
| 33 | supporting surface |
| 34 | receiving surface |
| 35 | groove portion |
| 36 | resilient locking piece |
| 37 | locking projection |
| 40 | pressing member |
| 41 | wall-like base portion |
| 42 | pressing portion |
| 43 | pressing surface |
| 44 | partition wall |
| 50 | rubber plug |
| 51 | sealing hole |
| 52 | lip portion |
| 55 | holder |
| 56 | plate-like pushing portion |
| 57 | cable insertion hole |
| 58 | lock arm |
| 60 | terminal module |
| 61 | case |
| 62 | terminal fitting |
| 63 | terminal body portion |
| 64 | crimping portion |
| 70 | multi-core cable (cable) |
| 71 | power supply wire (wire) |
| 72 | ground wire (wire) |
| 73 | insulation coating |
| 75 | shielded cable (cable) |
| 76 | signal wire (wire) |
| 77 | differential pair wire |
| 78 | sheath |
| 79 | strain relief portion |

1. A connector, comprising:
a housing body formed with a module accommodation chamber and a routing space;
a cover for closing an opening of the routing space in an outer surface of the housing body;
a pressing member mounted in the routing space; and
a terminal module including a terminal fitting connected to a wire, the terminal module being inserted in the module accommodation chamber,
the wire drawn out into the routing space from the module accommodation chamber being routed while being sandwiched and bent between the cover and the pressing member, and
a mounting direction of the pressing member into the routing space being a direction approaching the module accommodation chamber.

2. The connector of claim 1, wherein:
the pressing member has a pressing surface facing the module accommodation chamber,
the cover includes a protrusion projecting in a direction intersecting the mounting direction of the pressing member, the protrusion being arranged in the routing space,
the protrusion is formed with a receiving surface for sandwiching the wire between the pressing surface and the receiving surface, and
a mounting direction of the cover on the housing body is the same direction as the projecting direction of the protrusion.

3. The connector of claim 2, wherein:
the wires include two signal wires constituting a differential pair wire,
the differential pair wire constitutes one shielded cable by being embedded in a twisted state in a sheath, and
a part embedded in the sheath, out of the differential pair wire, is sandwiched and bent between the cover and the pressing member.

4. The connector of claim 1, wherein:
the wires include a power supply wire and a ground wire,
the power supply wire and the ground wire constitute one multi-core cable by being embedded in an insulation coating, and
parts embedded in the insulation coating, out of the power supply wire and the ground wire, are sandwiched and bent between the cover and the pressing member.

5. The connector of claim 1, comprising a plurality of cables having the wires embedded therein, wherein:
the plurality of cables are routed side by side in a width direction intersecting a routing direction of the plurality of cables in the routing space, and
the pressing member includes a partition wall for partitioning between the plurality of cables.
